(19) United States
(12) Patent Application Publication
(10) Pub. No.: US 2025/0285052 A1
(43) Pub. Date: Sep. 11, 2025

(54) ELECTRONIC APPARATUS, A SYSYTEM FOR DISPATCHING A VEHICLE, A METHOD FOR DISPATCHING A VEHICLE, AND AN APPARATUS FOR CONTROLLING A VEHICLE

(71) Applicants: HYUNDAI MOTOR COMPANY, Seoul (KR); KIA CORPORATION, Seoul (KR)

(72) Inventors: Ju Hyun Noh, Hwaseong-si (KR); Soo Bin Choi, Hwaseong-si (KR); Jung Hwa Jung, Hwaseong-si (KR)

(73) Assignees: HYUNDAI MOTOR COMPANY, Seoul (KR); KIA CORPORATION, Seoul (KR)

(21) Appl. No.: 19/069,931

(22) Filed: Mar. 4, 2025

(30) Foreign Application Priority Data
Mar. 5, 2024 (KR) 10-2024-0031535
Sep. 13, 2024 (KR) 10-2024-0126035

(51) Int. Cl. G06Q 10/0631; G06Q 10/02; G06Q 50/47

(52) U.S. Cl. CPC G06Q 10/06315; G06Q 10/02; G06Q 50/47

(57) ABSTRACT

An electronic device includes a memory and a processor. The processor may obtain a phone number of a user, among a plurality of users, who wants to dispatch a vehicle included in a plurality of vehicles, obtain a record of departure or arrival of the user generated through a dispatch prior to dispatching the vehicle based on the phone number, provide one or more example stops to the user based on at least one of at least one history stop included in the record of departure or arrival of the user, at least one preset recommended stop not included in the at least one history stop, or any combination thereof, and dispatch a vehicle to a departure location to transport the user from the departure location to a specified stop based on an input of the user specifying one of the one or more example stops.

### CROSS-REFERENCE TO RELATED APPLICATIONS

This application claims the benefit of and priority to Korean Patent Application No. 10-2024-0031535, filed on Mar. 5, 2024, and Korean Patent Application No. 10-2024-0126035, filed on Sep. 13, 2024, the entire contents of both of which are hereby incorporated herein by reference.

### TECHNICAL FIELD

The present disclosure relates to an electronic device, a vehicle dispatching system, a vehicle dispatching method, and a vehicle control device.

### BACKGROUND

The statements in this section merely provide background information related to the present disclosure and may not constitute prior art.

With the increasing pace of technological advancement, the issue of alienation among the digitally disadvantaged, who have relatively low access to digital devices and services, is becoming more prominent. Accordingly, technical improvements have been pursued to improve accessibility of the digitally disadvantaged. As the population decreases, the trend of reducing the number of public vehicles deployed in areas with low populations continues. Recently, with the advancement of information and communication technology, a technology for dispatching a vehicle through an electronic device has been developed. The technology for dispatching a vehicle is able to satisfy user demands with limited vehicles by dispatching vehicles according to user demands.

### SUMMARY

The present disclosure has been made to solve the above-mentioned problems occurring in the prior art while advantages achieved by the prior art are maintained intact.

Aspects of the present disclosure provide an electronic device, a vehicle dispatching system, a vehicle dispatching method, and a vehicle control device for dispatching a vehicle through an electronic device available for multiple users.

Aspects of the present disclosure provide an electronic device, a vehicle dispatching system, a vehicle dispatching method, and a vehicle control device for protecting personal information of each of multiple users.

Aspects of the present disclosure provide an electronic device, a vehicle dispatching system, a vehicle dispatching method, and a vehicle control device for improving user convenience.

Aspects of the present disclosure provide an electronic device, a vehicle dispatching system, a vehicle dispatching method, and a vehicle control device for improving the accessibility of vehicle calling by simplifying a vehicle dispatching process.

Aspects of the present disclosure provide an electronic device, a vehicle dispatching system, a vehicle dispatching method, and a vehicle control device for reducing maintenance costs.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an electronic device is provided. The electronic device includes a memory and a processor. The processor may obtain a phone number of a user who wants to dispatch a predetermined vehicle included in a plurality of vehicles among a plurality of users. The processor may also obtain a record of departure or arrival of the user generated through a dispatch prior to dispatching the predetermined vehicle based on the phone number. The processor may further provide one or more example stops to the user based on at least one of at least one history stop included in the record of departure or arrival of the user, at least one preset recommended stop not included in the at least one history stop, or any combination thereof. The processor may additionally dispatch a vehicle to a departure location to transport the user from the departure location to a specified stop based on an input of the user specifying one of the one or more example stops.

According to an example, the processor may provide the user with a guide indicating that a previously-dispatched vehicle is traveling to the departure location, if it is identified that there is a record of the user dispatching the previously-dispatched vehicle besides the predetermined vehicle based on the phone number. The processor may also obtain a record of departure or arrival of the user based on the phone number if it is identified that there is no record of the user dispatching the previously-dispatched vehicle based on the phone number.

According to an example, the processor may provide the user with a guide for membership registration if it is identified that the user is not a registered member based on the phone number. The processor may also obtain the record of departure or arrival of the user based on the phone number if it is identified that the user is the registered member based on the phone number.

According to an example, the processor may provide the user with one or more example stops sorted such that the at least one history stop precedes the at least one recommended stop.

According to an example, the processor may provide the user with the one or more example stops sorted based on an order in which the record of departure or arrival of the user occurred, if it is determined based on the record of departure or arrival of the user that the at least one history stop exists. The processor may also provide the user with the one or more example stops sorted based on the recommended stop, if it is determined based on the record of departure or arrival of the user that the at least one history stop does not exist.

According to an example, the processor may provide the user with the one or more example stops sorted such that a history stop included in the record of arrival of the user among the at least one history stop precedes a history stop included in the record of departure of the user among the at least one history stop if the record of departure of the user and the record of arrival of the user has occurred due to a single trip.

According to an example, the processor may provide the user with a guide indicating that the user is unable to dispatch the predetermined vehicle for a specified first time period if a record of the user canceling a dispatch is identified based on the phone number. The processor may also provide the user with a guide indicating that the user is unable to dispatch the predetermined vehicle for a specified second time period if a record of the user not boarding a vehicle according to a previous dispatch is identified based on the phone number.

According to an example, the processor may identify the one or more example stops such that the at least one recommended stop is included in the one or more example stops. The number of one or more example stops may be less than a specified number.

According to another aspect of the present disclosure, a vehicle dispatching system is provided. The vehicle dispatching system includes an electronic device and a server. A processor included in the electronic device may obtain a phone number of a user who wants to dispatch a predetermined vehicle included in a plurality of vehicles among a plurality of users. The processor included in the electronic device may also transmit the phone number to the server and receive a record of departure or arrival of the user generated through a previous dispatch prior to dispatching the predetermined vehicle. The processor included in the electronic device may further provide one or more example stops to the user based on at least one of at least one history stop included in the record of departure or arrival of the user, or at least one preset recommended stop not included in the at least one history stop, or any combination thereof. The processor included in the electronic device may additionally transmit, to the server, a signal for dispatching a vehicle to a departure location to transport the user from the departure location to a specified stop based on an input of the user specifying one of the one or more example stops.

According to an example, a processor included in the server may receive the phone number from the electronic device and identify the record of departure or arrival of the user based on the phone number. The processor included in the server may transmit the record of departure or arrival of the user to the electronic device. The processor included in the server may also dispatch a vehicle to the departure location to transport the user from the departure location to the specified stop. The processor included in the server may identify whether the user is a registered member based on the phone number and transmit to the electronic device an indication of whether the user is the registered member.

According to an example, the processor included in the server may identify, based on the phone number, whether there is a record of the user canceling a dispatch, or whether there is a record of the user not boarding a vehicle according to the previous dispatch. The processor included in the server may transmit, to the electronic device, an indication of whether there is the record of the user canceling the previous dispatch, or whether there is the record of not boarding a vehicle according to the previous dispatch.

According to an example, When the one or more example stops may be provided to the user, the one or more example stops may be sorted such that the at least one history stop precedes the at least one recommended stop.

According to yet another aspect of the present disclosure, a vehicle dispatching method is provided. The vehicle dispatching method includes obtaining, by an electronic device, a phone number of a user who wants to dispatch a predetermined vehicle included in a plurality of vehicles among a plurality of users. The vehicle dispatching method also includes transmitting, by the electronic device, the phone number to a server. The vehicle dispatching method additionally includes receiving, by the server, the phone number from the electronic device. The vehicle dispatching method also includes identifying, by the server, a record of departure or arrival of the user generated through a dispatch prior to dispatching the predetermined vehicle based on the phone number. The vehicle dispatching method additionally includes transmitting, by the server, the record of departure or arrival of the user to the electronic device. The vehicle dispatching method further still includes receiving, by the electronic device, the record of departure or arrival of the user and providing, by the electronic device, one or more example stops to the user based on at least one of at least one history stop included in the record of departure or arrival of the user, or at least one preset recommended stop not included in the at least one history stop, or any combination thereof. The vehicle dispatching method further still includes transmitting, by the electronic device, to the server, a signal for dispatching a vehicle to a departure location to transport the user from the departure location to a specified stop based on an input of the user specifying one of the one or more example stops. The vehicle dispatching method additionally includes dispatching, by the server, a vehicle to the departure location to transport the user from the departure location to the specified stop.

According to an example, the vehicle dispatching method may further include providing, by the electronic device, the user with a guide indicating that a previously-dispatched vehicle is traveling to the departure location, if it is identified that there is a record of the user dispatching the previously-dispatched vehicle besides the predetermined vehicle based on the phone number. The vehicle dispatching method may additionally include obtaining, by the electronic device, a record of departure or arrival of the user based on the phone number if it is identified that there is no record of the user dispatching the previously-dispatched vehicle based on the phone number.

According to an example, the vehicle dispatching method may further include identifying, by the server, whether the user is a registered member based on the phone number, transmitting, by the server, to the electronic device an indication of whether the user is the registered member. The vehicle dispatching method may additionally include providing, by the electronic device, the user with a guide for membership registration if it is identified that the user is not the registered member based on the phone number. The vehicle dispatching method may also include identifying, by the electronic device, the record of departure or arrival of the user based on the phone number if it is identified that the user is the registered member based on the phone number.

According to an example, providing, by the electronic device, the one or more example stops to the user may include providing, by the electronic device, the user with one or more example stops sorted such that the at least one history stop precedes the at least one recommended stop.

According to an example, providing, by the electronic device, the one or more example stops to the user may include providing, by the electronic device, the user with the one or more example stops sorted based on an order in which the record of departure or arrival of the user has occurred, if it is determined based on the record of departure or arrival of the user that the at least one history stop exists, and providing, by the electronic device, the user with the one or more example stops sorted based on the recommended stop, if it is determined based on the record of departure or arrival of the user that the at least one history stop does not exist.

According to an example, providing, by the electronic device, the one or more example stops to the user may include providing the user with the one or more example stops sorted such that a history stop included in the record of arrival of the user among the at least one history stop precedes a history stop included in the record of departure of the suer among the at least one history stop if the record of departure of the user and the record of arrival of the user has occurred due to a single trip.

According to an example, the vehicle dispatching method may further include providing, by the electronic device, the user with a guide indicating that the user is unable to dispatch the predetermined vehicle for a specified first time period if a record of the user canceling a dispatch is identified based on the phone number. The vehicle dispatching method may additionally include providing, by the electronic device, the user with a guide indicating that the user is unable to dispatch the predetermined vehicle for a specified second time period if a record of the user not boarding a vehicle according to a previous dispatch is identified based on the phone number.

According to an example, providing, by the electronic device, the one or more example stops to the user may include identifying, by the electronic device, the one or more example stops such that the at least one recommended stop is included in the one or more example stops. The number of one or more example stops may be less than a specified number.

According to yet another aspect of the present disclosure, an electronic device is provided. The electronic device includes a memory and a processor. The processor may obtain a stop at an arrival location of a user, among a plurality of users, who wants to dispatch a predetermined vehicle included in a plurality of vehicles. The arrival location is specified according to a user input, among one or more example stops provided based on at least one history stop identified according to a phone number of the user and included in a record of departure or arrival of the user generated through at least one of a previous dispatch prior to dispatching the predetermined vehicle, at least one preset recommended stop not included in the at least one history stop, or any combination thereof. The processor may also perform control to provide a vehicle to a departure location to transport the user to the specified stop.

### BRIEF DESCRIPTION OF THE DRAWINGS

The above and other objects, features, and advantages of the present disclosure should become more apparent from the following detailed description taken in conjunction with the accompanying drawings, in which:

FIG. 1 is a block diagram illustrating a configuration of an electronic device, according to an embodiment of the present disclosure;

FIG. 2 is a block diagram illustrating a configuration of a vehicle dispatching system, according to an embodiment of the present disclosure;

FIG. 3 is a block diagram illustrating a configuration of a vehicle control device, according to an embodiment of the present disclosure;

FIG. 4 illustrates an example of obtaining a user's phone number, performed in an electronic device, a vehicle dispatching system, a vehicle dispatching method, and a vehicle control device, according to embodiments of the present disclosure;

FIG. 5 illustrates an example of an example stop provided to a user in an electronic device, a vehicle dispatching system, a vehicle dispatching method, and a vehicle control device, according to embodiments of the present disclosure;

FIG. 6 illustrates an example of a vehicle dispatch in an electronic device, a vehicle dispatching system, a vehicle dispatching method, and a vehicle control device, according to embodiments of the present disclosure;

FIG. 7 illustrates an example of a guide for membership registration in an electronic device, a vehicle dispatching system, a vehicle dispatching method, and a vehicle control device, according to embodiments of the present disclosure;

FIG. 8 illustrates an example of a guide indicating that any vehicle is not dispatched in an electronic device, a vehicle dispatching system, a vehicle dispatching method, and a vehicle control device, according to embodiments of the present disclosure;

FIG. 9 illustrates a flowchart of operations of an electronic device for dispatching a vehicle to a departure location in an electronic device, a vehicle dispatching system, a vehicle dispatching method, and a vehicle control device, according to embodiments of the present disclosure;

FIG. 10 illustrates a flowchart of operations of an electronic device for dispatching a vehicle to a departure location in an electronic device, a vehicle dispatching system, a vehicle dispatching method, and a vehicle control device, according to embodiments of the present disclosure;

FIG. 11 illustrates an example of signaling between an electronic device and a server in an electronic device, a vehicle dispatching system, a vehicle dispatching method, and a vehicle control device, according to embodiments of the present disclosure; and

FIG. 12 illustrates a computing system related to an electronic device, a vehicle dispatching system, a vehicle dispatching method, and a vehicle control device, according to embodiments of the present disclosure.

### DETAILED DESCRIPTION

Hereinafter, some embodiments of the present disclosure are described in detail with reference to the accompanying drawings. In adding the reference numerals to the components of each drawing, it should be noted that the identical or equivalent components are designated by the identical numeral even if the components are displayed on different drawings. Further, in the present disclosure, a detailed description of well-known features or functions has been omitted in order to not unnecessarily obscure the gist of the present disclosure.

In describing the components of the examples according to the present disclosure, terms such as first, second, “A”, “B”, (a), (b), and the like may be used. These terms are merely intended to distinguish one component from another component. The terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as having such in the present disclosure.

In addition, in the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

When a component, device, element, or the like of the present disclosure is described as having a purpose or performing an operation, function, or the like, the component, device, or element should be considered herein as being “configured to” meet that purpose or perform that operation or function.

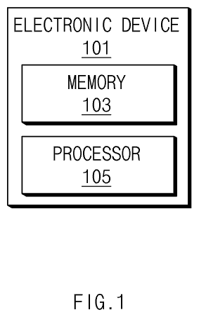

Hereinafter, embodiments of the present disclosure are described in detail with reference to FIGS. 1-12.

FIG. 1 is a block diagram illustrating a configuration of an electronic device, according to an embodiment of the present disclosure.

Referring to FIG. 1, an electronic device 101 may include a memory 103 and a processor 105. The memory 103 may store at least one instruction. The processor 105 may execute the at least one instruction stored in the memory 103.

According to an example, the electronic device 101 may be used by a plurality of users. For example, the electronic device 101 (e.g., a kiosk) may be located in a public place and used by a plurality of users. Any one of the plurality of users may, via the electronic device 101, dispatch a vehicle (e.g., a bus) to a departure location to transport the user from the departure location to a specified stop based on a user input. However, aspects of the present disclosure are not limited thereto.

According to an example, the processor 105 of the electronic device 101 may obtain a phone number of a user, of the plurality of users, who wants to dispatch a certain vehicle included in a plurality of vehicles.

According to an example, the processor 105 of the electronic device 101 may provide the user with a guide indicating that a previously-dispatched vehicle is traveling to a departure location if it is identified based on the obtained phone number that there is a record of the user dispatching the previously-dispatched vehicle, in addition to dispatching a certain vehicle. According to an example, the processor 105 of the electronic device 101 may obtain a record of the user's departure or arrival based on the phone number if it is identified based on the obtained phone number that there is no record of the user dispatching the previously-dispatched vehicle.

According to an example, the processor 105 of the electronic device 101 may provide the user with a guide for membership registration if it is identified based on the obtained phone number that the user is not a registered member. According to an example, the processor 105 of the electronic device 101 may obtain a record of the user's departure or arrival based on the phone number if it is identified based on the obtained phone number that the user is a registered member. Whether the user is a registered member may be identified based on whether there is a record of the user dispatching a vehicle.

According to an example, the processor 105 of the electronic device 101 may obtain, based on the phone number, a record of the user's departure or arrival, that has been generated by the dispatch prior to dispatching the certain vehicle. For example, the record of the user's departure may include information about a stop that is the departure location of the user who has dispatched the vehicle via the dispatch. For example, the record of the user's arrival may include information about a stop at the arrival location of the user who has dispatched the vehicle via the dispatch. However, the present disclosure is not limited thereto.

According to an example, the processor 105 of the electronic device 101 may provide the user with one or more example stops based on at least one of at least one history stop included in the record of the user's departure or arrival, or at least one preset recommended stop not included in the at least one history stop, or any combination thereof. For example, the at least one preset recommended stop may be provided to the user based on a region in which the electronic device 101 is deployed. For example, the at least one preset recommended stop may be preset independently of the user.

According to an example, the processor 105 of the electronic device 101 may provide the user with one or more example stops sorted based on the recommended stop, if it is determined based on the record of departure or arrival of the user that the at least one history stop does not exist.

According to an example, if it is determined based on the record of departure or arrival of the user that the at least one history stop exists, the processor 105 of the electronic device 101 may provide the user with the one or more example stops sorted, for example, such that the at least one history stop precedes the at least one recommended stop.

According to an example, if it is determined based on the records of the user's departure or arrival that the at least one history stop exists, the processor 105 of the electronic device 101 may provide the user with the one or more example stops sorted based on the order in which the record of the user's departure or the record of the user's arrival has occurred.

According to an example, the processor 105 of the electronic device 101 may identify the one or more example stops such that at least one recommended stop is included in the one or more example stops. The number of one or more example stops may be less than a specified number (e.g., about 10).

According to an example, if a record of the user's departure and a record of the user's arrival has occurred due to a single trip, the processor 105 of the electronic device 101 may provide the user with the one or more example stops sorted such that a history stop included in the record of the user's arrival precedes a history stop included in the record of the user's departure among the at least one history stop.

According to an example, the processor 105 of the electronic device 101 may, based on a user input specifying one of the one or more example stops, dispatch a vehicle to the departure location to transport the user from the departure location to the specified stop. For example, the user may specify one of the example stops as the his or her arrival location.

According to an example, the processor 105 of the electronic device 101 may provide a user with a guide indicating that the user is unable to dispatch any vehicle for a specified first time period (e.g., about 30 minutes) if a record of the user canceling a dispatch is identified based on the phone number.

According to an example, the processor 105 of the electronic device 101 may provide the user with a guide indicating that the user is unable to dispatch any vehicle for a specified second time period (e.g., about one hour) if a record of the user not boarding a vehicle according to a previous dispatch is identified based on the phone number.

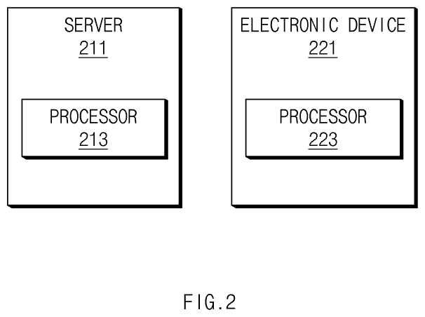

FIG. 2 is a block diagram illustrating a configuration of a vehicle dispatching system, according to an embodiment of the present disclosure.

Referring to FIG. 2, a vehicle dispatching system may include a server 211 and an electronic device 221. The server 211 may include a processor 213. The electronic device 221 may include a processor 223.

According to an example, the processor 223 included in the electronic device 221 may obtain a phone number of a user, of a plurality of users, who wants to dispatch a certain vehicle included in a plurality of vehicles. According to an example, the processor 223 included in the electronic device 221 may transmit the phone number to the server 211.

According to an example, the processor 213 included in the server 211 may receive the phone number from the electronic device 221.

According to an example, the processor 213 included in the server 211 may identify whether the user is a registered member based on the obtained phone number. According to an example, the processor 213 included in the server 211 may transmit, to the electronic device 221, an indication of whether the user is a registered member.

According to an example, the processor 223 of the electronic device 221 may provide the user with a guide for membership registration if it is identified based on the obtained phone number that the user is not a registered member. For example, the guide for membership registration may include a guide for obtaining acceptance of the terms and conditions. According to an example, the processor 223 of the electronic device 221 may obtain a record of the user's departure or arrival based on the phone number if it is identified based on the obtained phone number that the user is a registered member.

According to an example, the processor 213 included in the server 211 may identify the record of the user's departure or arrival based on the phone number. According to an example, the processor 213 included in the server 211 may transmit the record of the user's departure or arrival to the electronic device 221.

According to an example, the processor 223 included in the electronic device 221 may receive a record of a user's departure or arrival generated through a previous dispatch.

According to an example, the processor 223 included in the electronic device 221 may provide the user with one or more example stops based on at least one of at least one history stop included in the record of the user's departure or arrival, at least one preset recommended stop not included in the at least one history stop, or any combination thereof. The preset stop may be determined by criteria established by a service operator.

According to an example, the processor 223 included in the electronic device 221 may, based on a user input specifying one of the one or more example stops, transmit to the server a signal for dispatching a vehicle to the departure location to transport the user from the departure location to the specified stop.

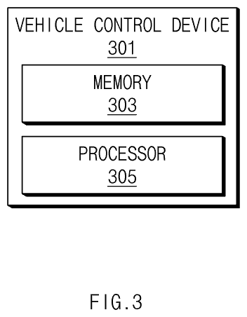

FIG. 3 is a block diagram illustrating a configuration of a vehicle control device, according to an example of the present disclosure.

Referring to FIG. 3, a vehicle control device 301 may include a memory 303 and a processor 305. The memory 303 may store at least one instruction. The processor 305 may execute the at least one instruction stored in the memory 303.

According to an example, the processor 305 of the vehicle control device 301 may obtain, from the one or more example stops, a stop at the user's arrival location specified based on a user input.

According to an example, the stop at the arrival location may be provided based on at least one of at least one history stop which is identified by the user's phone number and included in the record of the user's departure or arrival generated through a dispatch prior to a dispatch for a certain vehicle, or at least one recommended stop which is not included in the at least one history stop and is preset, or any combination thereof.

According to an example, the user may include a user who wants to dispatch a certain vehicle included in the plurality of vehicles from the plurality of users.

According to an example, the processor 305 of the vehicle control device 301 may cause a vehicle for transporting the user to a specified stop to travel to a departure location.

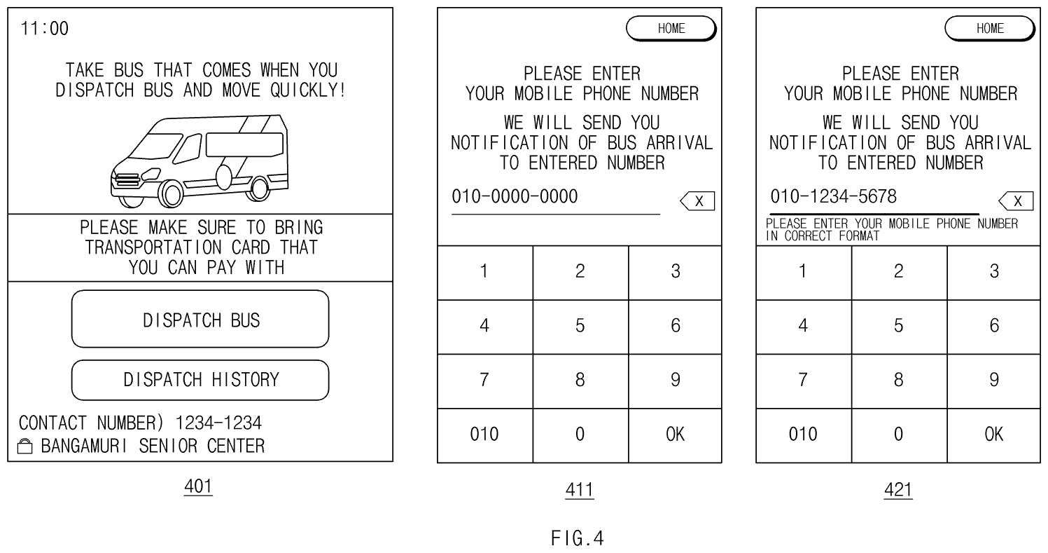

FIG. 4 illustrates an example of obtaining a user's phone number, performed in an electronic device, a vehicle dispatching system, a vehicle dispatching method, and a vehicle control device, according to embodiments of the present disclosure.

Referring to FIG. 4, a first screen 401 may include a graphic allowing a user to dispatch a vehicle. A second screen 411 may include a graphic allowing the user to enter a phone number. A third screen 421 may include a graphic allowing the user to re-enter the phone number if the phone number entered by the user is not verified.

According to an example, an electronic device available for use by a plurality of users may provide the first screen 401, the second screen 411, and the third screen 421 to a user. For example, a kiosk may present the first screen 401, the second screen 411, and the third screen 421 to a user via a display included in the kiosk.

According to an example, on the first screen 401, the electronic device may provide the user with a graphic indicating that the user is able to dispatch a vehicle. A button (e.g., dispatch bus) included on the first screen 401 may allow the user to initiate a process for dispatching a vehicle.

According to an example, on the second screen 411, the electronic device may provide a user with a graphic allowing the user to enter a phone number. The user may enter a phone number via buttons (e.g., 1, 2, 3, 4, 5, 6, 7, 8, 9, 0, 010, OK) included on the second screen 411. As the user enters the phone number, the electronic device may obtain the phone number.

According to an example, on the third screen 421, the electronic device may provide the user with a graphic allowing the user to re-enter the phone number if the user has entered the phone number that is not verified. The user may identify that the user needs to re-enter the phone number through a guide included in the third screen 421 (e.g., please enter a mobile number in correct format).

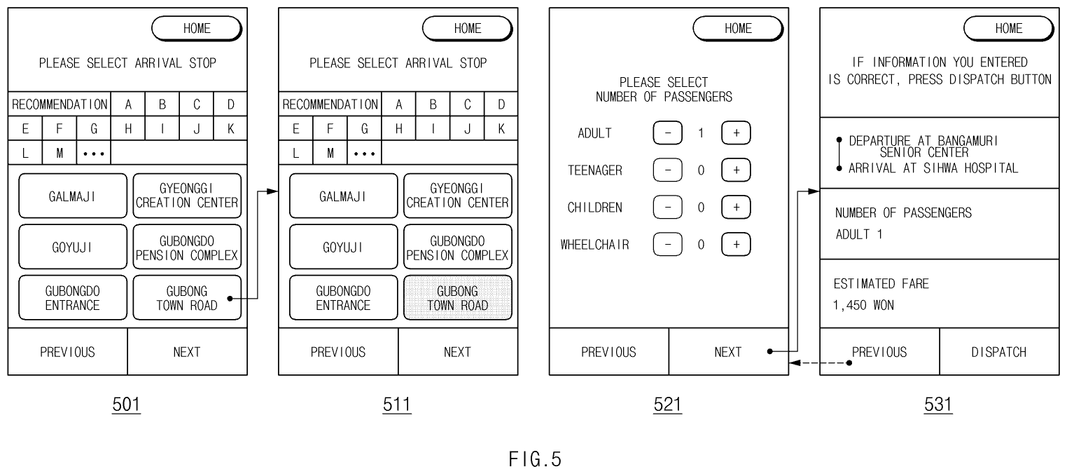

FIG. 5 illustrates an example of an example stop provided to a user in an electronic device, a vehicle dispatching system, a vehicle dispatching method, and a vehicle control device, according to embodiments of the present disclosure.

Referring to FIG. 5, a first screen 501 may include a graphic providing an example stop to a user. A second screen 511 may include a graphic for obtaining a user input to specify one of example stops to a user. A third screen 521 may include a graphic for obtaining a user input to select the number of users. A fourth screen 531 may include a graphic for confirming dispatch information. According to an example, an electronic device (e.g., a kiosk) available for use by a plurality of users may provide the first screen 501, the second screen 511, the third screen 521, and the fourth screen 531 to a user. For example, the kiosk may present the first screen 501, the second screen 511, the third screen 521, and the fourth screen 531 to a user via a display included in the kiosk.

According to an example, on the first screen 501, the electronic device may provide the user with one or more example stops.

According to an example, if the at least one history stop does not exist, the example stop may include only a recommended stop.

According to an example, if the at least one history stop exists, the one or more example stops may be arranged such that the at least one history stop (e.g., Galmaji, Gyeonggi Creative Center, Goryeoji) precedes the at least one recommended stop (e.g., Gubongdo Pension Complex, Gubongdo Entrance, Gubong Town Road).

According to an example, the electronic device may sort and provide at least one history stop to the user based on the order in which the record of the user's departure or arrival occurred. For example, if a record corresponding to a first history stop (e.g., Galmaji) precedes a record corresponding to a second history stop (e.g., Goryeoji), the first history stop may be sorted to precede the second history stop and provided to the user.

According to an example, if the record of the user's departure (e.g., the record of the user departing from Gyeonggi Creative Center) and the record of the user's arrival (e.g., the record of arriving at Galmaji) occurred based on a single trip (e.g., the user departing from Gyeonggi Creative Center and arriving at Galmaji), a history stop (e.g., Galmaji) included in the record of the user's arrival among the at least one history stop may be provided to the user before the at least one history stop included in the record of the user's departure (e.g., Gyeonggi Creative Center).

According to an example, the number of one or more example stops provided to the user may be less than a specified number (e.g., about six).

According to an example, on the second screen 511, the electronic device may provide a user with a graphic (e.g., the first screen 501) allowing the user to enter a phone number as the user selects a button (e.g., Previous) for returning to a previous phase. In other words, the electronic device may provide the user with a graphic allowing the user to enter a new phone number, rather than the phone number that the user entered prior to pressing the button to return to the previous phase.

According to an example, on the second screen 511, the electronic device may activate a button (e.g., Next) for proceeding to the next phase based on a user input specifying a stop at one of example stops being obtained.

According to an example, if the user selects the button (e.g., Next) for proceeding to the next phase, the electronic device may provide the user with a graphic (e.g., the third screen 521) allowing the user to specify the number of users on board.

According to an example, on the third screen 521, the electronic device may provide the user with a graphic allowing the user to specify the number of users on board.

The electronic device may provide the second screen 511 to the user if the user selects a button (e.g., Previous) for returning to the previous phase. The electronic device may provide the user with a graphic (e.g., the fourth screen 531) allowing the user to confirm dispatch information if the user selects the button (e.g., Next) for proceeding to the next phase.

According to an example, on the fourth screen 531, the electronic device may provide the user with a graphic allowing the user to confirm dispatch information.

According to an example, the dispatch information may include a departure location, a specified stop based on a user input, the selected number of occupants based on a user input, and an estimated fare.

According to an example, the electronic device may provide the user with a graphic (e.g., the third screen 521) allowing the user to specify the number of users on board if the user selects a button (e.g., Previous) for returning to the previous phase. If the user selects a button (e.g., Dispatch) for proceeding to the next phase, the electronic device may dispatch a vehicle to the departure location to transport the user from the departure location to a specified stop.

According to an example, the electronic device may perform an operation of substantially dispatching a vehicle if the user selects the number of occupants on the third screen 521.

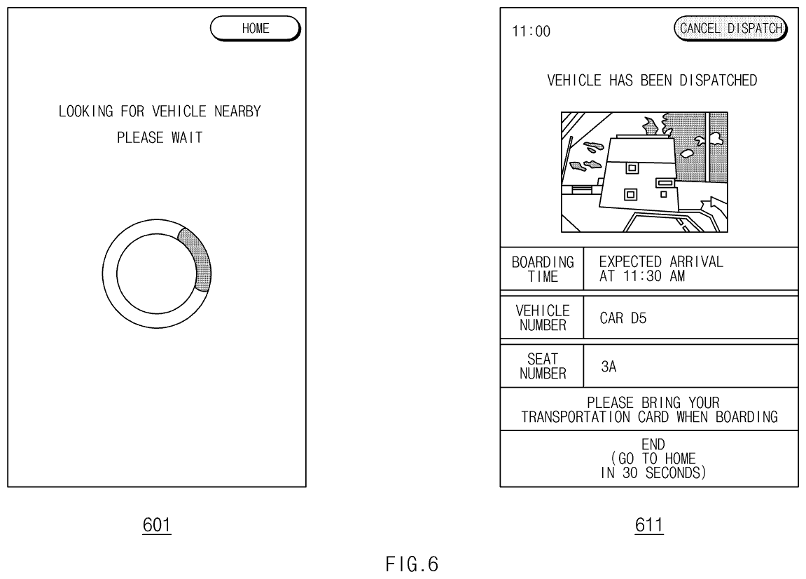

FIG. 6 illustrates an example of a vehicle dispatch in an electronic device, a vehicle dispatching system, a vehicle dispatching method, and a vehicle control device, according to embodiments of the present disclosure.

Referring to FIG. 6, a first screen 601 may include a graphic indicating to a user that a vehicle is in the process of being dispatched. A second screen 611 may include a graphic providing a user with information about the vehicle being dispatched.

According to an example, the electronic device may transmit to the user's terminal a notification indicating that the dispatch is successful, if the dispatch is successful, based on a phone number.

According to an example, on the second screen 611, the graphic providing information about the vehicle may include at least one of a scheduled boarding time, a vehicle number, or a seat number, or any combination thereof.

The electronic device, the vehicle dispatching system, the vehicle dispatching method, and the vehicle control device according to embodiments may, upon successful dispatching of a vehicle, transmit the details of the vehicle dispatch to the user based on the obtained phone number (e.g., communicate to the user via notification or text). Further, the electronic device, the vehicle dispatching system, the vehicle dispatching method, and the vehicle control device according to embodiments may transmit at least one of a stop, a scheduled boarding time, vehicle arrival information, or additional notifications, or any combination thereof to the user based on the phone number (e.g., communicate to the user via notification or text).

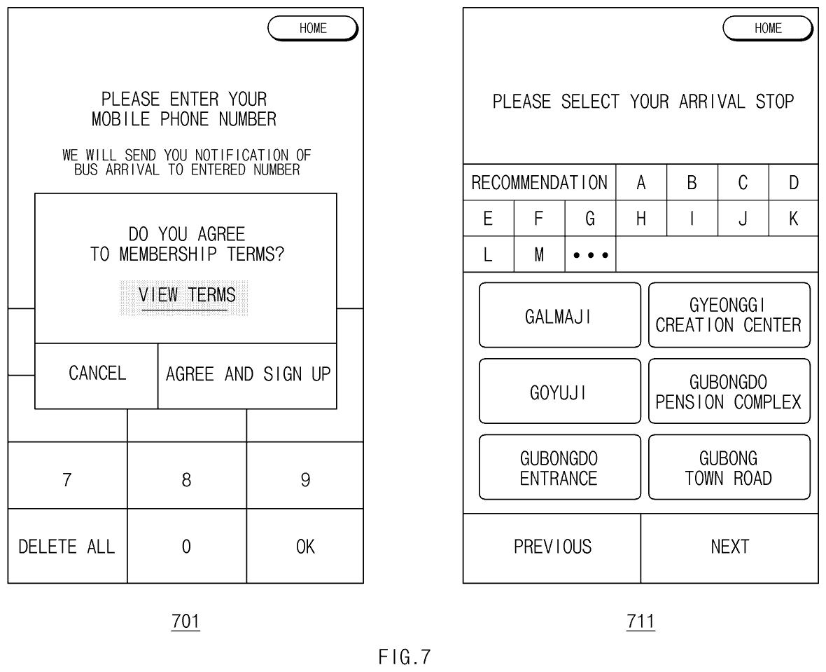

FIG. 7 illustrates an example of a guide for membership registration in an electronic device, a vehicle dispatching system, a vehicle dispatching method, and a vehicle control device, according to embodiments of the present disclosure.

Referring to FIG. 7, a first screen 701 may include a graphic for a guide for membership registration provided to a user if the user is not a registered member. A second screen 711 may include a graphic for providing an example stop to the user if the user has completed membership registration.

According to an example, an electronic device (e.g., a kiosk) available for use by a plurality of users may provide the first screen 701 and the second screen 711 to a user. For example, the kiosk may present the first screen 701 and the second screen 711 to a user via a display included in the kiosk.

According to an example, on the first screen 701, the electronic device may provide the user with a guide for membership registration if the user is not a registered member.

According to an example, on the second screen 711, the electronic device may provide the user with one or more example stops. The example stop may include only a recommended stop because at least one history stop does not exist.

In an example, the electronic device may provide the user with a screen for accepting terms and conditions for membership registration without a separate membership registration process if it is determined based on the phone number that the user is not a registered member. Whether the user is a registered member may be identified based on whether there is a record of the user dispatching a vehicle. If there is the record of the user dispatching a vehicle, the electronic device may provide the user with a graphic (e.g., second screen 711) that provides an example stop.

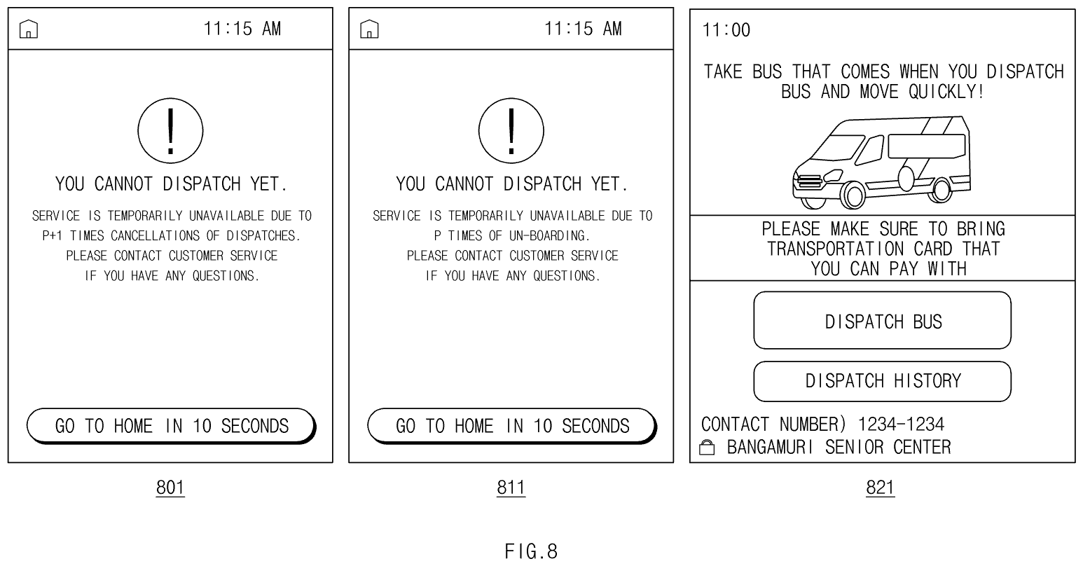

FIG. 8 illustrates an example of a guide indicating that any vehicle is not dispatched in an electronic device, a vehicle dispatching system, a vehicle dispatching method, and a vehicle control device, according to embodiments of the present disclosure.

Referring to FIG. 8, on a first screen 801, the electronic device may provide a user with a guide indicating that the user is unable to dispatch any vehicle for a specified first time period (e.g., about 30 minutes) if a record the user canceling a dispatch is identified based on the phone number.

On a second screen 811, the electronic device may provide a user with guide indicating that the user is unable to dispatch any vehicle for a specified second time period if a record of the user not boarding a vehicle according to a previous dispatch is identified based on the phone number.

On third screen 821, the electronic device may provide the user with a graphic (e.g., first screen 401 of FIG. 4) for dispatching a vehicle.

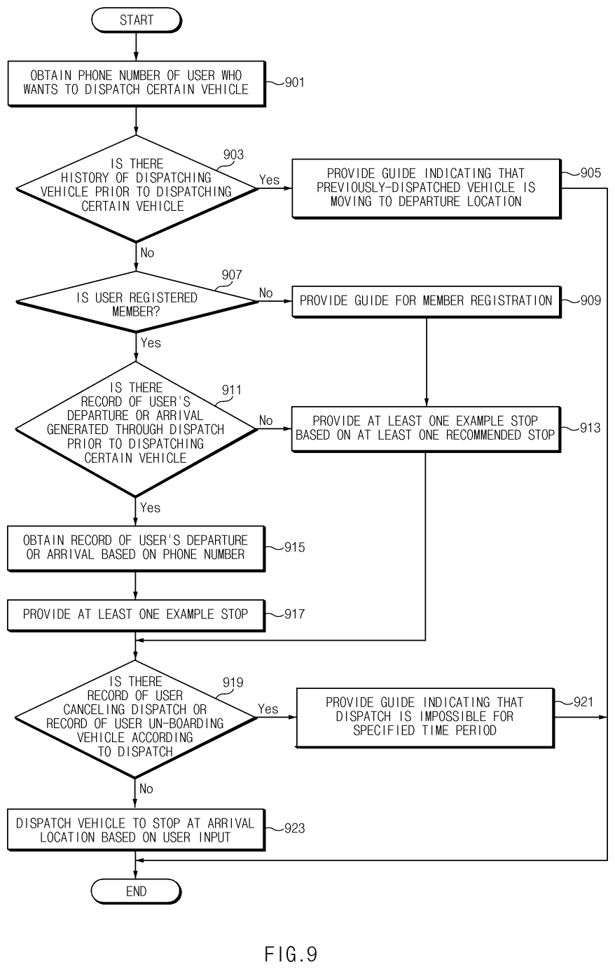

FIG. 9 illustrates a flowchart of operations of an electronic device for dispatching a vehicle to a departure location in an electronic device, a vehicle dispatching system, a vehicle dispatching method, and a vehicle control device, according to embodiments of the present disclosure.

Hereinafter, it is assumed that the electronic device 101 of FIG. 1 or the electronic device 221 of FIG. 2 performs a process of FIG. 9. Also, in the description of FIG. 9, the operations described as being performed by the electronic device may be understood as being performed by the processor 105 of the electronic device 101 of FIG. 1.

According to an example, in a first operation 901, the processor of the electronic device may obtain a phone number of a user who wants to dispatch a certain vehicle. According to an example, the certain vehicle may be included in a plurality of vehicles. A user may include one of a plurality of users.

According to an example, in a second operation 903, the processor of the electronic device may determine whether there is a record of the user dispatching a previously-dispatched vehicle, besides a certain vehicle. If there is the record of the user dispatching a previously-dispatched vehicle, besides dispatching a certain vehicle, the processor of the electronic device may perform a third operation 905. If there is no record of the user dispatching a previously-dispatched vehicle, the processor of the electronic device may perform a fourth operation 907.

According to an example, in the third operation 905, the processor of the electronic device may provide a guide indicating that the previously-dispatched vehicle is traveling to the departure location.

According to an example, in the fourth operation 907, the processor of the electronic device may determine whether the user is a registered member. If the user is a registered member, the processor of the electronic device may perform a fifth operation 911. If the user is not a registered member, the processor of the electronic device may perform a sixth operation 909.

According to an example, in the sixth operation 909, the processor of the electronic device may provide the user with a guide for membership registration.

According to an example, in the fifth operation 911, the processor of the electronic device may determine whether there is a record of the user's departure or arrival generated by a dispatch prior to dispatching a certain vehicle. If there is a record of the user's departure or arrival, the processor of the electronic device may perform a seventh operation 915. If a record of the user's departure or arrival does not exist, the processor of the electronic device may perform an eighth operation 913.

According to an example, in the eighth operation 913, the processor of the electronic device may provide the user with one or more example stops based on at least one recommended stop.

According to an example, in the seventh operation 915, the processor of the electronic device may obtain a record of the user's departure or arrival based on a phone number.

According to an example, in the ninth operation 917, the processor of the electronic device may provide one or more example stops to the user.

According to an example, in a tenth operation 919, the processor of the electronic device may determine whether there is a record of the user canceling a dispatch or not boarding a vehicle according to a previous dispatch. If there is no record of the user canceling a dispatch or not boarding a vehicle according to a previous dispatch, the processor of the electronic device may perform an eleventh operation 921. If there is no record of the user canceling a dispatch or not boarding a vehicle according to a previous dispatch, the processor of the electronic device may perform a twelfth operation 923.

In the eleventh operation 921, the processor of the electronic device may provide the user with a guide indicating that the user is unable to dispatch a certain vehicle for a specified time period.

In the twelfth operation 923, the processor of the electronic device may dispatch a vehicle to a departure location based on a user input.

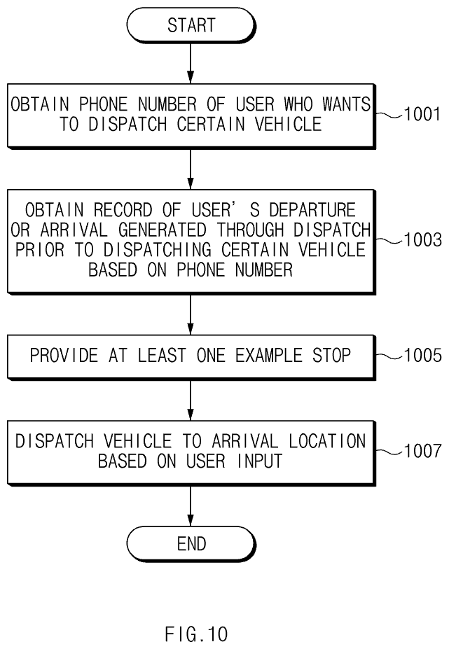

FIG. 10 illustrates a flowchart of operations of an electronic device for dispatching a vehicle to a departure location in an electronic device, a vehicle dispatching system, a vehicle dispatching method, and a vehicle control device, according to embodiments of the present disclosure.

Hereinafter, it is assumed that the electronic device 101 of FIG. 1 or the electronic device 221 of FIG. 2 performs a process of FIG. 10. Also, in the description of FIG. 10, the operations described as being performed by the electronic device may be understood as being performed by the processor 105 of the electronic device 101.

Referring to FIG. 10, according to an example, in a first operation 1001, the processor of the electronic device may obtain a phone number of a user who wants to dispatch a certain vehicle.

According to an example, the user may include a user who wants to dispatch a certain vehicle included in the plurality of vehicles from the plurality of users.

According to an example, in a second operation 1003, the processor of the electronic device may obtain a record of the user's departure or arrival generated by a dispatch prior to dispatching a certain vehicle, based on a phone number.

According to an example, in a third operation 1005, the processor of the electronic device may provide one or more example stops.

According to an example, the processor of the electronic device may provide the user with one or more example stops based on at least one of at least one history stop included in the record of the user's departure or arrival, or at least one preset recommended stop not included in the at least one history stop, or any combination thereof.

According to an example, in a fourth operation 1007, the processor of the electronic device may dispatch a vehicle to a departure location based on a user input.

According to an example, the user input may specify one of the one or more example stops. The vehicle may include a vehicle for transporting the user from a departure location to a specified stop, based on a user input.

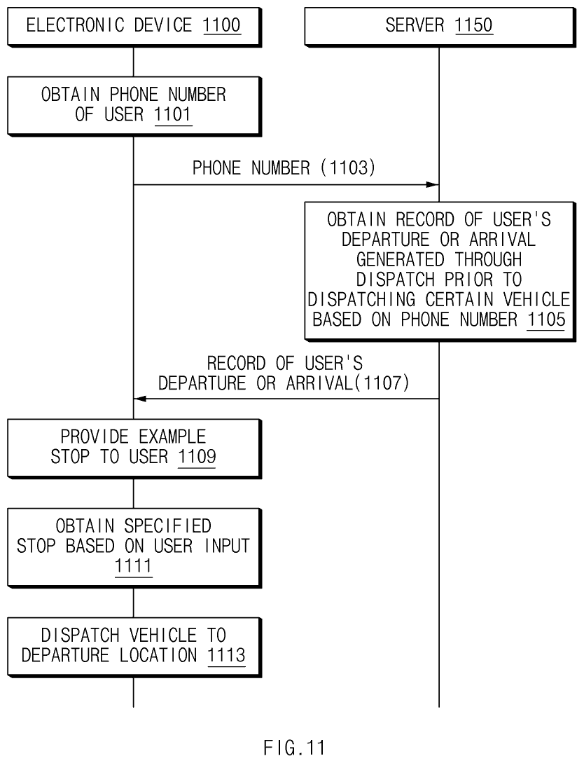

FIG. 11 illustrates an example of signaling between an electronic device and a server in an electronic device, a vehicle dispatching system, a vehicle dispatching method, and a vehicle control device, according to embodiments of the present disclosure.

Hereinafter, it is assumed that the server 211 of FIG. 2 or the electronic device 221 of FIG. 2 performs a process of FIG. 11. Also, in the description of FIG. 11, the operations described as being performed by the server may be understood to be performed by the processor 213 of the server 211 of FIG. 2. Also, in the description of FIG. 11, the operations described as being performed by the electronic device may be understood as being performed by the processor 223 of the electronic device 221 of FIG. 2.

Referring to FIG. 11, according to an example, in a first operation 1101, a processor of an electronic device 1100 may obtain a phone number of a user.

According to an example, in a second operation 1103, the processor of the electronic device 1100 may transmit the phone number to a server 1150. A processor of the server 1150 may receive the phone number from the electronic device 1100.

According to an example, in a third operation 1105, the processor of the server 1150 may obtain a record of the user's departure or arrival generated by a dispatch prior to dispatching a certain vehicle, based on a phone number.

According to an example, in a fourth operation 1107, the processor of the server 1150 may transmit the record of the user's departure or arrival to the electronic device 1100. The processor of the electronic device 1100 may receive the record of the user's departure or arrival from the server 1150.

According to an example, in a fifth operation 1109, the processor of the electronic device 1100 may provide an example stop to the user.

According to an example, in a sixth operation 1111, the processor of the electronic device 1100 may obtain a specified stop based on a user input.

According to an example, in a seventh operation 1113, the processor of the electronic device 1100 may dispatch a vehicle to a departure location.

According to an example, an electronic device for dispatching a vehicle, a vehicle dispatching system, a vehicle dispatching method, and a vehicle control device may provide a service for dispatching a demand-responsive vehicle (e.g., a bus) via an electronic device (e.g., a kiosk). The demand-responsive vehicle may be rerouted in response to the user's dispatch to provide the user with a service of transporting the user.

In an example, the electronic device may transmit the user's dispatch history to the server and provide the user with an estimated route identified based on the transmitted dispatch history. The user may board the vehicle after confirming the estimated route received via the electronic device.

In the past, the service was provided using personal terminals as electronic devices, which made it difficult for the transport disadvantaged (e.g. the elderly over 65 years old) to register for membership, verify identity, register their cards, select their departure and arrival locations, and board demand-responsive vehicles through personal terminals. In addition, a boarding rate for demand-responsive vehicles was lower than a baseline boarding rate because users with disadvantaged mobility could not confirm the departure location and a departure time after the dispatch was made. In addition, user abandonment rates were higher than a baseline abandonment rate due to fees for non-boarding. User dissatisfaction rates were higher than a baseline dissatisfaction rate, especially in rural areas with small populations, due to the lack of alternative transport options.

To compensate for this, a phone dispatch method was implemented where users are able to dispatch a vehicle via their phones. Through a phone with a consultant, users may able to go through a process of registering for membership, verifying identity, registering their card, and selecting their departure and arrival locations. However, the accuracy of the user's information obtained from a dispatch via a phone may be lower than the accuracy of the user's information obtained from a dispatch via an electronic device. In addition, the cost of maintaining the phone dispatch method may be higher than the cost of maintaining the electronic device dispatch method. The reason for the phone dispatch method is that the consultant needs to be on standby during operating hours.

The electronic device for dispatching a vehicle, the vehicle dispatching system, the vehicle dispatching method, and the vehicle control device according to embodiments of the present disclosure may increase accessibility of demand-responsive vehicles to persons with disadvantaged mobility.

A user of the electronic device for dispatching a vehicle, the vehicle dispatching system, the vehicle dispatching method, and the vehicle control device according to embodiments of the present disclosure may dispatch a demand-responsive vehicle by simply entering a phone number, without any personal authentication and sign-up process.

Because the electronic device is used by multiple users, providing users with a history of stops previously used based on the phone number may be subject to restrictions under the Personal Information Protection Act. Therefore, in the electronic device for dispatching a vehicle, the vehicle dispatching system, the vehicle dispatching method, and the vehicle control device according to embodiments of the present disclosure, de-identification of personal information may be necessary.

The electronic device for dispatching a vehicle, the vehicle dispatching system, the vehicle dispatching method, and the vehicle control device according to embodiments of the present disclosure may provide the user with recommended stops along with the history stops to perform de-identification of personal information.

The electronic device for dispatching a vehicle, the vehicle dispatching system, the vehicle dispatching method, and the vehicle control device according to embodiments of the present disclosure may provide a vehicle dispatch service to a user based on input of a phone number and a stop at an arrival location.

The electronic device for dispatching a vehicle, the vehicle dispatching system, the vehicle dispatching method, and the vehicle control device according to embodiments of the present disclosure may allow a user to make a phone call after the user alights at a stop which is an arrival location, thereby assisting the user in travelling in areas without the electronic device. For example, the server may transmit, to the user's terminal, a telephone number for dispatching a vehicle via a telephone call after the user alights.

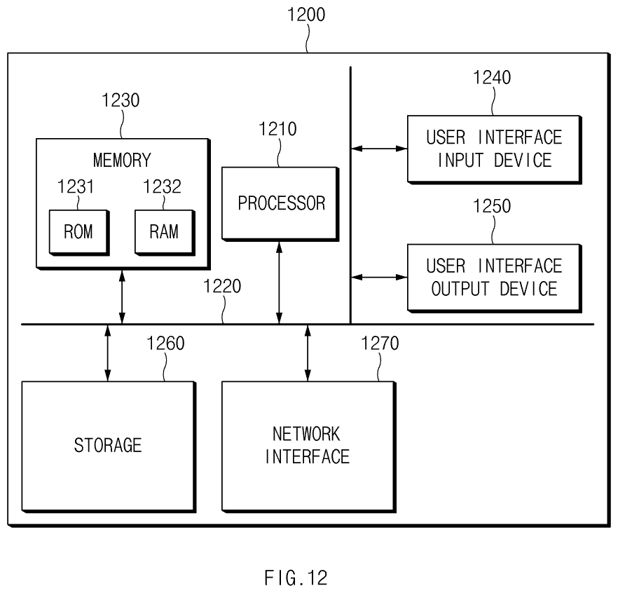

FIG. 12 illustrates a computing system associated with an electronic device, a vehicle dispatching system, a vehicle dispatching method, and a vehicle control device, according to embodiments of the present disclosure.

Referring to FIG. 12, a computing system 1200 may include at least one processor 1210, a memory 1230, a user interface input device 1240, a user interface output device 1250, storage 1260, and a network interface 1270, which are connected with each other via a bus 1220.

The processor 1210 may be a central processing unit (CPU) or a semiconductor device that processes instructions stored in the memory 1230 and/or the storage 1260. The memory 1230 and the storage 1260 may include various types of volatile or non-volatile storage media. For example, the memory 1230 may include a ROM (Read Only Memory) 1231 and a RAM (Random Access Memory) 1232.

Thus, the operations of the method or the algorithm described in connection with the examples disclosed herein may be embodied directly in hardware or a software module executed by the processor 1210, or in a combination thereof. The software module may reside on a storage medium (that is, the memory 1230 and/or the storage 1260) such as a RAM, a flash memory, a ROM, an EPROM, an EEPROM, a register, a hard disk, a removable disk, and a CD-ROM.

The example storage medium may be coupled to the processor 1210, and the processor 1210 may read information out of the storage medium and may record information in the storage medium. Alternatively, the storage medium may be integrated with the processor 1210. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

Accordingly, the examples disclosed in the present disclosure are not intended to limit the technical idea of the present disclosure but to describe the present disclosure, and the scope of the technical idea of the present disclosure is not limited by the examples. The scope of protection of the present disclosure should be interpreted by the appended claims, and all technical ideas within the scope equivalent thereto should be construed as being included in the scope of the present disclosure.

The present technology may dispatch a vehicle through an electronic device available for multiple users.

In addition, the present technology may protect the personal information of each of multiple users.

In addition, the present technology may improve the convenience of users.

In addition, the present technology may improve the accessibility of vehicle calling by simplifying the vehicle dispatching process.

In addition, the present technology may reduce maintenance costs.

In addition, various effects may be provided that are directly or indirectly understood through the disclosure.

Hereinabove, although the present disclosure has been described with reference to examples and the accompanying drawings, the present disclosure is not limited thereto, but may be variously modified and altered by those having ordinary skill in the art to which the present disclosure pertains without departing from the spirit and scope of the present disclosure claimed in the appended claims, and all technical ideas within the scope equivalent thereto should be construed as being included in the scope of the present disclosure.

What is claimed is:

1. An electronic device comprising:
a memory; and
a processor,
wherein the processor is configured to:
obtain a phone number of a user, among a plurality of users, who wants to dispatch a predetermined vehicle included in a plurality of vehicles among a plurality of users,
obtain a record of departure or arrival of the user generated through a dispatch prior to dispatching the predetermined vehicle based on the phone number,
provide one or more example stops to the user based on at least one of at least one history stop included in the record of departure or arrival of the user, at least one preset recommended stop not included in the at least one history stop, or any combination thereof, and
dispatch a vehicle to a departure location to transport the user from the departure location to a specified stop based on an input of the user specifying one of the one or more example stops.

2. The electronic device of claim 1, wherein the processor is configured to:
provide the user with a guide indicating that a previously-dispatched vehicle is traveling to the departure location, if it is identified that there is a record of the user dispatching the previously-dispatched vehicle besides the predetermined vehicle based on the obtained phone number; and
obtain a record of departure or arrival of the user based on the phone number if it is identified that there is no record of the user dispatching the previously-dispatched vehicle based on the obtained phone number.

3. The electronic device of claim 1, wherein the processor is configured to:
provide the user with a guide for membership registration if it is identified that the user is not a registered member based on the obtained phone number; and
obtain the record of departure or arrival of the user based on the phone number if it is identified that the user is the registered member based on the obtained phone number.

4. The electronic device of claim 1, wherein the processor is configured to provide the user with one or more example stops sorted such that the at least one history stop precedes the at least one recommended stop.

5. The electronic device of claim 1, wherein the processor is configured to:
provide the user with the one or more example stops sorted based on an order in which the record of departure or arrival of the user has occurred, if it is determined based on the record of departure or arrival of the user that the at least one history stop exists; and
provide the user with the one or more example stops sorted based on the recommended stop, if it is determined based on the record of departure or arrival of the user that the at least one history stop does not exist.

6. The electronic device of claim 1, wherein the processor is configured to provide the user with the one or more example stops sorted such that a history stop included in the record of arrival of the user among the at least one history stop precedes a history stop included in the record of departure of the user among the at least one history stop if the record of departure of the user and the record of arrival of the user has occurred due to a single trip.

7. The electronic device of claim 1, wherein the processor is configured to:
provide the user with a guide indicating that the user is unable to dispatch the predetermined vehicle for a specified first time period if a record of the user canceling a dispatch is identified based on the phone number; and
provide the user with a guide indicating that the user is unable to dispatch the predetermined vehicle for a specified second time period if a record of the user not boarding a vehicle according to a previous dispatch is identified based on the phone number.

8. The electronic device of claim 1, wherein the processor is configured to identify the one or more example stops such that the at least one recommended stop is included in the one or more example stops,
wherein a number of the one or more example stops is less than a specified number.

9. A vehicle dispatching system comprising:
an electronic device; and
a server,
wherein a processor included in the electronic device is configured to:
obtain a phone number of a user, among a plurality of users, who wants to dispatch a predetermined vehicle included in a plurality of vehicles,
transmit the phone number to the server,
receive a record of departure or arrival of the user generated through a previous dispatch prior to dispatching the predetermined vehicle,
provide one or more example stops to the user based on at least one of at least one history stop included in the record of departure or arrival of the user, at least one preset recommended stop not included in the at least one history stop, or any combination thereof, and
transmit, to the server, a signal for dispatching a vehicle to a departure location to transport the user from the departure location to a specified stop based on an input of the user specifying one of the one or more example stops, and
wherein a processor included in the server is configured to:
receive the phone number from the electronic device,
identify the record of departure or arrival of the user based on the phone number,
transmit the record of departure or arrival of the user to the electronic device, and
dispatch a vehicle to the departure location to transport the user from the departure location to the specified stop.

10. The vehicle dispatching system of claim 9, wherein the processor included in the server is configured to:
identify whether the user is a registered member based on the obtained phone number; and
transmit to the electronic device an indication of whether the user is the registered member.

11. The vehicle dispatching system of claim 9, wherein the processor included in the server is configured to:
identify, based on the phone number, whether there is a record of the user canceling a dispatch, or whether there is a record of the user not boarding a vehicle according to the previous dispatch; and
transmit, to the electronic device, an indication of whether there is the record of the user canceling the previous dispatch, or whether there is the record of not boarding a vehicle according to the previous dispatch.

12. The vehicle dispatching system of claim 9,
When the one or more example stops are provided to the user, the one or more example stops are sorted such that the at least one history stop precedes the at least one recommended stop.

13. A vehicle dispatching method comprising:
obtaining, by an electronic device, a phone number of a user, among a plurality of users, who wants to dispatch a predetermined vehicle included in a plurality of vehicles;
transmitting, by the electronic device, the phone number to a server;
receiving, by the server, the phone number from the electronic device;
identifying, by the server, a record of departure or arrival of the user generated through a dispatch prior to dispatching the predetermined vehicle based on the phone number;
transmitting, by the server, the record of departure or arrival of the user to the electronic device;
receiving, by the electronic device, the record of departure or arrival of the user;
providing, by the electronic device, one or more example stops to the user based on at least one of at least one history stop included in the record of departure or arrival of the user, at least one preset recommended stop not included in the at least one history stop, or any combination thereof;
transmitting, by the electronic device to the server, a signal for dispatching a vehicle to a departure location to transport the user from the departure location to a specified stop based on an input of the user specifying one of the one or more example stops; and
dispatching, by the server, a vehicle to the departure location to transport the user from the departure location to the specified stop.

14. The vehicle dispatching method of claim 13, further comprising:
providing, by the electronic device, the user with a guide indicating that a previously-dispatched vehicle is traveling to the departure location, if it is identified that there is a record of the user dispatching the previously-dispatched vehicle besides the predetermined vehicle based on the phone number; and
obtaining, by the electronic device, a record of departure or arrival of the user based on the phone number if it is identified that there is no record of the user dispatching the previously-dispatched vehicle based on the phone number.

15. The vehicle dispatching method of claim 13, further comprising:
identifying, by the server, whether the user is a registered member based on the phone number;
transmitting, by the server, to the electronic device an indication of whether the user is the registered member;
providing, by the electronic device, the user with a guide for membership registration if it is identified that the user is not the registered member based on the phone number; and
identifying, by the electronic device, the record of departure or arrival of the user based on the phone number if it is identified that the user is the registered member based on the phone number.

16. The vehicle dispatching method of claim 13, wherein providing, by the electronic device, the one or more example stops to the user includes providing, by the electronic device, the user with one or more example stop sorted such that the at least one history stop precedes the at least one recommended stop.

17. The vehicle dispatching method of claim 13, wherein providing, by the electronic device, the one or more example stops to the user includes:
providing, by the electronic device, the user with the one or more examples stop sorted based on an order in which the record of departure or arrival of the user occurred, if it is determined based on the record of departure or arrival of the user that the at least one history stop exists; and
providing, by the electronic device, the user with the one or more example stops sorted based on the recommended stop, if it is determined based on the record of departure or arrival of the user that the at least one history stop does not exist.

18. The vehicle dispatching method of claim 13, wherein providing, by the electronic device, the one or more example stops to the user includes providing the user with the one or more example stops sorted such that a history stop included in the record of arrival of the user among the at least one history stop precedes a history stop included in the record of departure of the user among the at least one history stop if the record of departure of the user and the record of arrival of the user has occurred due to a single trip.

19. The method of claim 13, further comprising:
providing, by the electronic device, the user with a guide indicating that the user is unable to dispatch the predetermined vehicle for a specified first time period if a record of the user canceling a dispatch is identified based on the phone number; and
providing, by the electronic device, the user with a guide indicating that the user is unable to dispatch the predetermined vehicle for a specified second time period if a record of the user not boarding a vehicle according to a previous dispatch is identified based on the phone number.

20. The vehicle dispatching method of claim 13, wherein providing, by the electronic device, the one or more example stops to the user includes identifying, by the electronic device, the one or more example stops such that the at least one recommended stop is included in the one or more example stops, and
wherein a number of the one or more example stops is less than a specified number.
